(19) United States
(12) Patent Application Publication
(10) Pub. No.: US 2006/0033939 A1
(43) Pub. Date: Feb. 16, 2006

(54) Apparatus and method for converting color gamut of color image

(76) Inventor: Dong-Il Han, Seoul (KR)

Correspondence Address: COOPER & DUNHAM, LLP, 1185 AVENUE OF THE AMERICAS, NEW YORK, NY, 10036, US

(21) Appl. No.: 11/194,392

(22) Filed: Aug. 1, 2005

(30) Foreign Application Priority Data
Aug. 12, 2004 (KR) 10-2004-0063564

(51) Int. Cl. H04N 1/60

(52) U.S. Cl. 358/1.9

(57) ABSTRACT

Disclosed herein are an apparatus and method for converting a color gamut of an input color image. The apparatus includes a three-dimensional (3-D) difference lookup table, a color interpolator and an adder. The 3-D difference lookup table stores the differences between input values corresponding to the upper n bits of the input color image and the 3-D converted color data thereof. The color interpolator performs 3-D interpolation using 3-D converted data, which are output from the 3-D lookup difference lookup table, and 3-D color data corresponding to the lower m bits of the input color image. The adder receives the output of the color interpolator and the input color image and outputs an image whose colors have been finally converted.

### BACKGROUND OF THE INVENTION

1. Field of the Invention

The present invention -relates generally to an apparatus for improving the reproducibility of an input color image, which is reproduced by a display device, in real time, and, more particularly, to an apparatus and method for correcting the colors of an input color image in real time using a three-dimensional lookup table so that the colors are suitable for the characteristics of the display device, so as to correct the differences in the color reproducibility -of display devices, which are generated due to the differences in color reproduction mechanism, using a color gamut mapping technique.

2. Description of the Related Art

Recently, with the development of digital Television (TV) technology, the resolution of TV signal images is considerably improved, so that the users of digital TVs can view high quality images, compared to those of conventional analog TVs. In order to display high resolution images, various types of display devices are continuously being developed. Accordingly, large-screen Plasma Display Panels (PDPs) and large-screen Liquid Crystal Displays (LCDs) as well as widely used direct view-type Cathode Ray Tubes (CRTs) have been developed. Furthermore, projection TVs utilizing Projection TV tubes (PRTs), Digital Light Processing (DLP), LCDs and Liquid Crystal on Silicon (LCOS) have been developed, and are attracting attention as display devices for high image quality, High Definition (HD) TVs.

Meanwhile, there is a problem in that individual display devices have unique display characteristics, and display different colors for the same image signal input due to the differences in display characteristics. It is frequently observed that the same type of display devices display different colors for the same signal input due to physical, electrical or mechanical differences that were caused in manufacturing processes. In particular, there are large differences in color reproducibility because currently developed display devices have insufficient stability in their parts due to rapid technological development.

Due to the differences in method of reproducing colors in various types of display devices, the various types of display devices display different colors for the same image signal input. Furthermore, the same type of display devices also display different colors for the same image signal input. Though research for overcoming the differences is being conducted, there is the difficulty of taking into account all of the differences in phosphor, the differences in color filter and the differences in the brightness level generation characteristics for respective colors.

Currently, in most display devices, the various characteristics thereof are adjusted using a circuit shown in FIG. 1A. That is, the brightness, contrast, hue, chroma, etc. of a display screen are adjusted using the circuit shown in FIG. 1A. Such a method can adjust color reproduction characteristics required for a specific type of display device, but has difficulty in adjusting the differences in color reproduction characteristics in different types of display devices. That is, as described above, respective types of display devices have different color reproduction mechanisms, utilize different types of phosphors and color filters and have different gamma characteristics for representing various brightness levels, so that the display devices reproduce different colors for the same color input.

A method that can be easily considered to solve the above-described problems is to store and use output RGB values corresponding to input RGB values as shown in FIG. 1B, so that respective display devices are allowed to reproduce desired colors by mapping arbitrary input RGB values to the output values of the display devices. This method is the most perfect one from a theoretical point of view, but is very difficult to implement. That is, to implement a three-dimensional (3-D) lookup table for the method, a storage space of 256×256×256×3 bits is required. When the lookup table is implemented using an Application Specific Integrated Circuit (ASIC), hardware including about five hundred million gates is required, so that it is impossible in practice to implement the lookup table using hardware.

A method capable of considerably reducing the amount of required hardware while employing the idea of FIG. 1b includes a method of employing a 3-D lookup table whose resolution is appropriately reduced, the configuration of which is illustrated in FIGS. 1C and 1D.

This method serves to considerably reduce the size of a 3-D lookup table using the configuration shown in FIG. 1C and implement the remainder using a 3-D interpolation technique. This technique serves to reduce the conversion resolution at which an input RGB image is converted into an output RGB image, and does not generate a difference in the overall image quality. Furthermore, to actually implement the 3-D lookup table of FIG. 1C, a plurality of a one-dimensional (1-D) lookup tables is connected and used in parallel, as shown in FIG. 1D.

Color gamut mapping tests were conducted using such a 3-D lookup table and color gamut mapping rules were analyzed, with the result that it was understood that most mapped color gamut values were not greatly different from input values. In this case, the amount of required hardware could be further reduced by storing only the differences between the mapped color gamut values and the input values when calculating output values for respective input color signal values. However, the conventional method does not have sufficient provision for this processing.

### SUMMARY OF THE INVENTION

Accordingly, the present invention has been made keeping in mind the above problems occurring in the prior art, and an object of the present invention is to provide an apparatus and method for converting the color gamut of a color image, which reduce the amount of required memory and hardware implementation cost by optimizing the conventional resolution saving 3-D lookup table in such a way as to appropriately sample the brightness levels of respective input RGB signals and store only the differences between the input color image values and converted color values at sampling locations, rather than the converted color values, when storing the converted color values at the sampling locations.

Another object of the present invention is to provide an apparatus and method for converting the color gamut of a color image, which can be applied regardless of the type of display devices, in real time and at low cost due to the simple hardware construction, can operate at high speed, and can improve the color reproducibility of various types of display devices.

In order to accomplish the above object, the present invention provides an apparatus for converting a color gamut of an input color image, including a 3-D difference lookup table for storing the differences between input values corresponding to the upper n bits of the input color image and the 3-D converted color data thereof; a color interpolator for performing 3-D interpolation using 3-D converted data, which are output from the 3-D lookup difference lookup table, and 3-D color data corresponding to the lower m bits of the input color image; and an adder for receiving the output of the color interpolator and the input color image, and outputting an image whose colors have been finally converted.

The 3-D lookup table stores converted values corresponding to input RGB values. This 3-D lookup table is different from the conventional one in that the 3-D lookup table of the present invention stores the differences between output converted values and input values, rather than the output converted values, thereby reducing the amount of memory by about 20-30%.

The 3-D lookup table can be implemented using software, but there are many difficulties in implementing the 3-D lookup table using hardware. In practice, the 3-D lookup table is composed of eight 1-D lookup tables, an address decoder, and a data switch.

The eight 1-D lookup tables used to constitute the 3-D difference lookup table each provide data at one vertex of a cube, and simultaneously provide differential converted values for an input color image, so that the interpolator and the adder can calculate appropriate converted values.

The address decoder functions to calculate locations at which data corresponding to respective RGB values are stored, and participates in operations of storing converted data off-line and generating converted data on-line.

The data switch is not necessarily required. However, by providing this block, the entire configuration of hardware can be optimally constructed. The data provided by the eight lookup tables constitute the vertices of a cube. The locations of the vertices of the cube are interchanged depending on the RGB values of an input color image. By converting the locations into appropriate locations, the 3-D interpolator can easily perform interpolation.

The 3-D interpolator functions to output differential converted color values corresponding to an input color image using differential converted color values at eight vertices and the image data of the LSB parts of the input color image.

The adder simultaneously receives differential converted values, which are generated by the 3-D interpolator, and image input values, which are used to calculate the differential converted values, calculates final converted color values, and outputs the finally converted color values.

The present invention provides a method of converting a color gamut of an input color image, including the steps of storing differences between input values corresponding to upper n bits of the input color image and 3-D converted color data thereof in a 3-D difference lookup table; performing 3-D interpolation using 3-D converted data, which are output from the 3-D lookup difference lookup table, and 3-D color data corresponding to lower m bits of the input color image, and receiving output of the color interpolator and the input color image, and outputting an image whose colors have been finally converted by an add operation.

The step of storing the differences in the 3-D lookup table includes the steps of calculating the addresses of the eight 1-D lookup tables using the input RGB values, and rearranging the color data, which are provided from the 1-D lookup tables, in appropriate order so as to facilitate the 3-D interpolation.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1D are diagrams illustrating conventional methods of converting color signals in a display device;

FIG. 2 is a block diagram illustrating an apparatus for converting the color gamut of a color image in accordance with an embodiment of the present invention;

FIG. 3 is a diagram illustrating the internal configuration of a 3-D difference lookup table according to the present invention;

FIG. 4 is a diagram illustrating the operation of a 3-D interpolator according to the present invention in detail;

FIG. 5 is a diagram illustrating the actual construction of the 3-D difference lookup table according to the present invention in detail; and

FIG. 6 is another diagram illustrating the actual construction of the 3-D difference lookup table according to the present invention in detail.

### DESCRIPTION OF THE PREFERRED EMBODIMENTS

Reference now should be made to the drawings, in which the same reference numerals are used throughout the different drawings to designate the same or similar components.

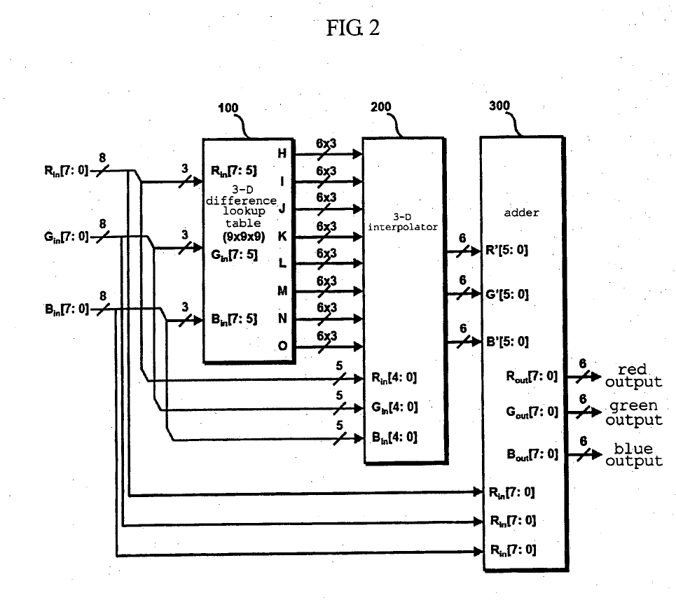

FIG. 2 is a block diagram illustrating an apparatus for converting the color gamut of a color image in accordance with an embodiment of the present invention.

Referring to FIG. 2, the apparatus for converting the color gamut of a color image in accordance with the embodiment of the present invention includes a 3-D difference lookup table 100, a 3-D interpolator 200, and an adder 300.

The 3-D difference lookup table 100 stores converted values corresponding to input RGB values. The 3-D difference lookup table 100 is different from the conventional one in that the 3-D difference lookup table 100 of the present invention stores the differences between output converted values and input values, rather than directly storing the output converted values, so that it can reduce the amount of required memory by about 20-40%.

The 3-D difference lookup table 100 actually includes eight 1-D lookup tables, an address decoder and a data switch.

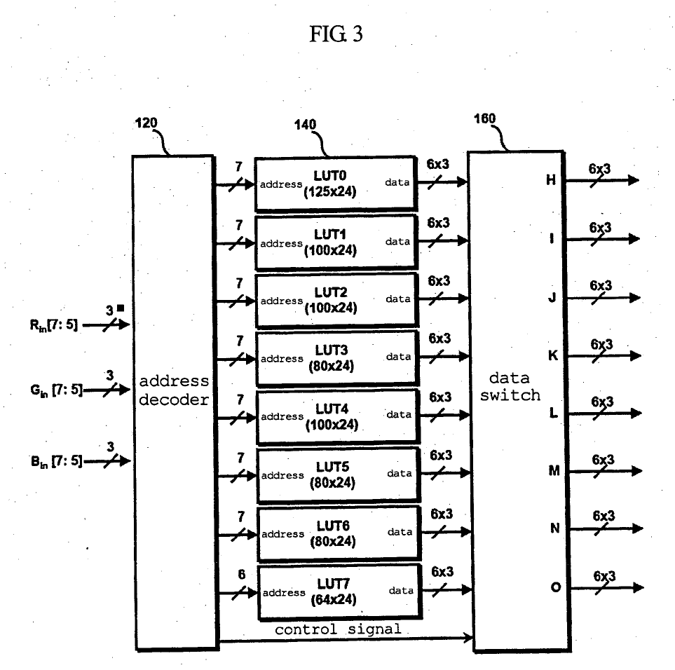

FIG. 3 is a diagram illustrating the construction of an address decoder 120, eight 1-D lookup tables 140 and a data switch 160 that constitute the 3-D difference lookup table 100.

The 3-D difference lookup table 100 includes the 1-D lookup tables 140 having different depths. Each of the 1-D lookup tables 140 provides a vertex of a 3-D cube. The eight 1-D lookup tables simultaneously provide differential converted values for a single input color image, so that the interpolator 200 and the adder 300 can calculate appropriate converted values.

Referring to FIG. 3, the address decoder 120 functions to calculate locations at which data corresponding to respective RGB values are stored, and participates in operations of storing converted data off-line and generating converted data on-line.

The data switch 160 is not necessarily required. However, by providing this block, the entire configuration of hardware can be optimally constructed. The data provided by the eight lookup tables 140 constitute the vertices of a cube. The locations of the vertices of the cube are interchanged depending on the RGB values of an input color image. By converting the locations into appropriate locations, the 3-D interpolator 200 can easily perform interpolation.

The eight lookup tables 140 store converted values corresponding to RGB values input to the 3-D lookup table 100.

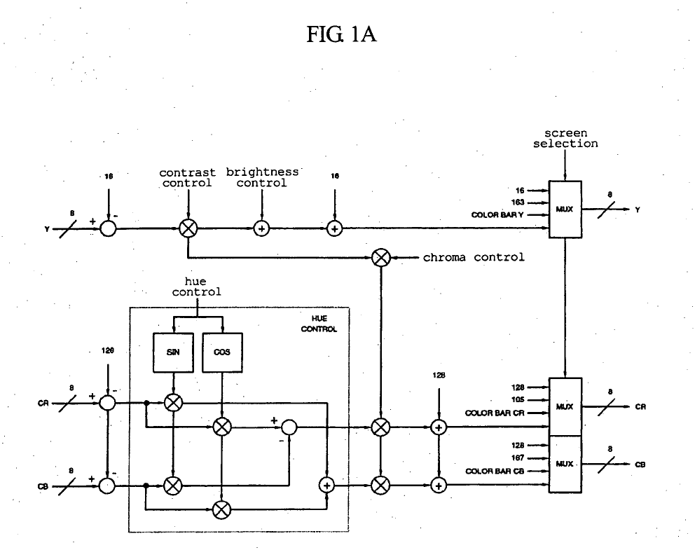

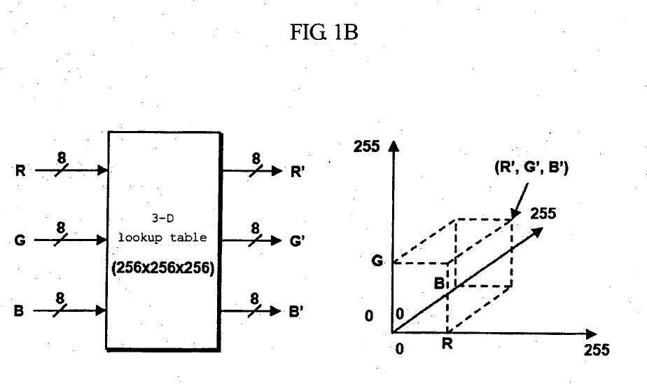

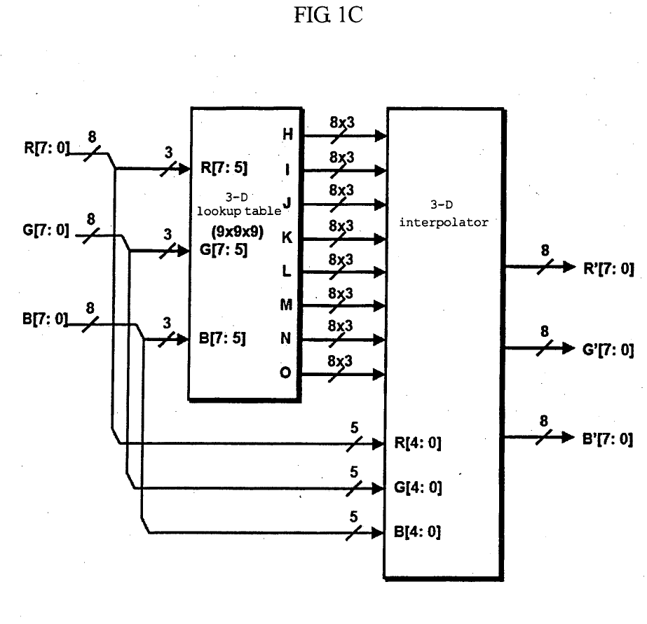

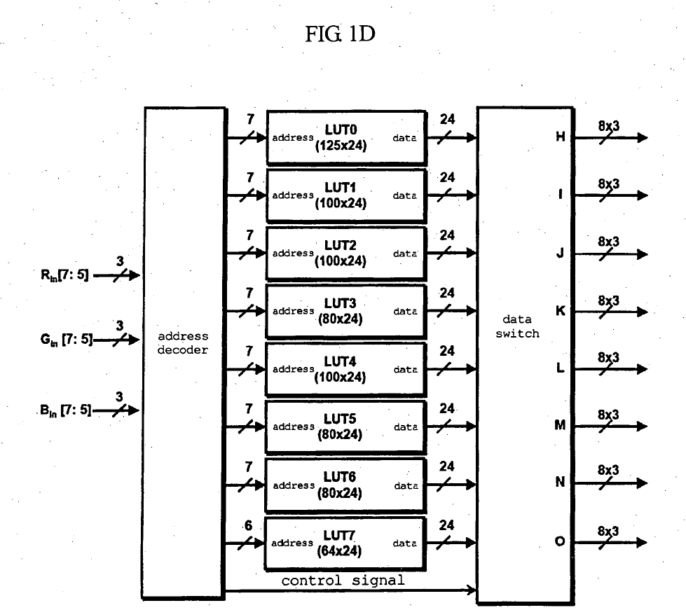

As illustrated in FIG. 1C, the conventional 3-D lookup table is used to store the results of color conversion that is performed on input RGB values. The 3-D lookup table 100 of the present invention does not store converted values for all input signals, but stores only converted values at a limited number of representative coordinates by appropriately sampling the levels of input signals. For example, when converted color values are stored for the parts of color signals sampled in 32 level units so as to construct the 3-D lookup table, each converted color value can be stored using the upper 3 bits of a color signal. When color input signals are represented by Rin, Gin and Bin and a color conversion function is represented by gm_{component}(.) color conversion values stored in the lookup table can be expressed by the follow Equations:
Rout[7:0]=gm_{red}(Rin[7:5], Gin[7:5], Bin[7:5]) (1)
Gout[7:0]=gm_{green}(Rin[7:5], Gin[7:5], Bin[7:5]) (2)
Bout[7:0]=gm_{blue}(Rin[7:5], Gin[7:5], Bin[7:5]) (3)

Various color conversions were performed using the above-described configuration, with the result that, in most cases, it is not necessary to store all of 8 or 10 bit image information for each R, G or B signal so as to store a conversion rule. By storing only correction values for a current input color image, storage space and entire hardware implementation cost can be considerably reduced. That is, construction is performed as described above and color conversion correction values for respective input images, not converted values, are stored in the lookup tables. When color input signals are represented by Rin, Gin and Bin and a color conversion function is represented by gm_{component}(.), color conversion correction values RD, GD and BD stored in the lookup table at an arbitrary storage point p may be represented as follows:
RDout,p[7:0]=Rin,p[7:5]−gm_{red}(Rin,p[7:5], Gin,p[7:5], Bin,p[7:5]) (4)
GDout,p[7:0]=Gin,p[7:5]−gm_{green}(Rin,p[7:5], Gin,p[7:5], Bin,p[7:5]) (5)
BDout,p[7:0]=Bin, p[7:5]−gm_{blue}(Rin,p[7:5], Gin,p[7:5], Bin,p[7:5]) (6)

In the above case, the MSB bit parts of RD[7:0], GC[7:0] and BD[7:0] become zero, so that it is not necessary to use 8 bit storage spaces. Even if 7, 6, 5 or 4 bit storage spaces are used, necessary color conversion can be sufficiently performed. In this case, the above Equations (4) to (6) can be implemented with the size of each storage space being reduced. The following Equations represent the case where 6 bit storage spaces are employed.
RDout,p[5:0]=Rin,p[7:5]−gm_{red}(Rin,p[7:5], Gin,p[7:5], Bin,p[7:5]) (7)
GDout,p[5:0]=Gin,p[7:5]−gm_{green}(Rin,p[7:5], Gin,p[7:5], Bin,p[7:5]) (8)
BDout,p[5:0]=Bin,p[7:5]−gm_{blue}(Rin,p[7:5], Gin,p[7:5], Bin,p[7:5]) (9)

In the above case, 6 bits are implemented to represent a negative number. As a result, the number of additional logics does not greatly increase, but the entire storage space of memory can be reduced by about 25%. Since the resolution of other image processing units is decreased, the overall use of hardware can be reduced.

The differential converted color values calculated by the Equations (7)˜(9) are stored in memory, when the power of the display device is turned on, or at the time of initialization. The converted color values may be changed in real time if necessary. From the results of tests, even if converted color values are changed in real time, the variation in color value instantaneously occurs in a corresponding pixel, which does not cause any problem in a display environment.

When a color conversion operation is performed, all of memory reading, 3-D interpolation and adding operations are normally performed within 5-7 pixels, even considering a high-speed (160 MHz) operation, and desired color conversion results can be acquired.

The difference lookup table 100 of FIG. 3 is illustrated to provide 6 bit output for each of the RGB channels, and the number of final output bits may be appropriately adjusted according to application cases.

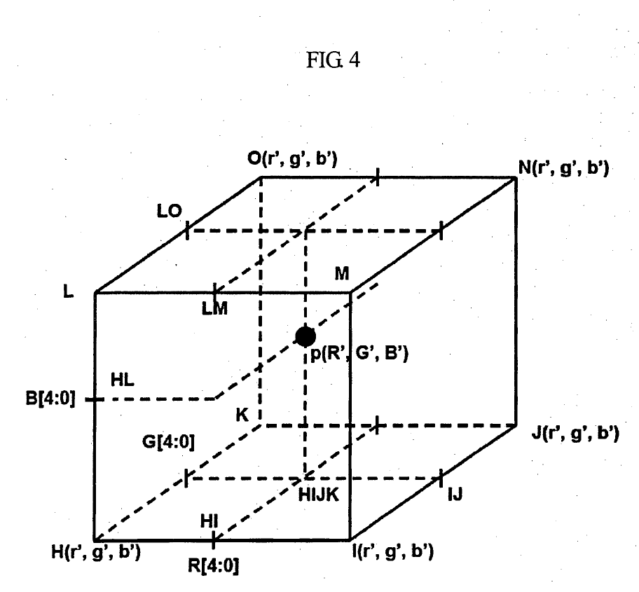

The 3-D interpolator 200 functions to output differential converted color values corresponding to an input color image using differential converted color values at eight vertices and the image data of the LSB parts of the input color image, as shown in FIG. 4.

That is, when the differential converted values of red components at the locations H, I, J and K of FIG. 4 are respectively represented by R_{H}, R_{I}, R_{J} and R_{K} and the LSB parts R[4:0], G[4:0] and B[4:0] of image data are respectively represented by r, g and b, the differential converted value of a red component at location HI is as follows:
R_{HI}=(R_{H}×(32−r)+R_{I}×r)/32 (10)

In the same manner, value RKJ can be obtained as follows:
R_{KJ}=(R_{K}×(32−r)+R_{J}×r)/32 (11)

The interpolated value at location HIJK is obtained using the two values and the following Equation.
R_{HIJK}=(R_{HI}×(32−g)+R_{KJ}×g)/32 (12)

Finally, the interpolated value of a red component at point p of FIG. 4 can be obtained using the following Equation:
R_{P}=(R_{HIJK}×(32−b)+R_{LMNO}×b)/32 (13)

In the same manner, the interpolated values of Green and Blue signals at point p can be obtained using the following Equations,
Gₚ=(G_{HIJK}×(32−b)+G_{LMNO}×b)/32 (14)
Bₚ=(B_{HIJK}×(32−b)+B_{LMNO}×b)/32 (15)

Using the above-described method, interpolated, differential converted color values at point p can be calculated for Red, Green and Blue components.

There are several additional considerations that should be taken into account when constructing the 3-D interpolator 200.

The first consideration is that eight pieces of differential color converted data at the vertices of a cube, which surround color input signal values Rin, Gin and Bin, must be simultaneously provided. For this purpose, the 3-D lookup table is actually composed of eight 1-D lookup tables, as illustrated in FIG. 3. For example, the LUT7 of FIG. 3 is a 1-D lookup table having a depth of 64 and a width of 6×3=18.

The address decoder 120 can provide a differential converted color value at the vertex of a cube, which includes a current color input value, using the upper n bits of the current color input value. In the case where n=3, each color input value is divided into eight sections, and nine converted color value storage locations for each color input channel are provided to perform interpolation.

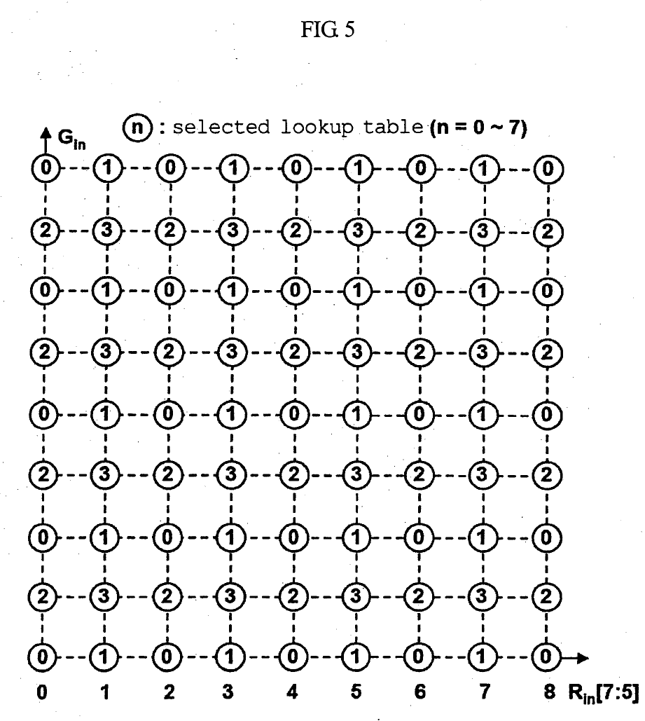

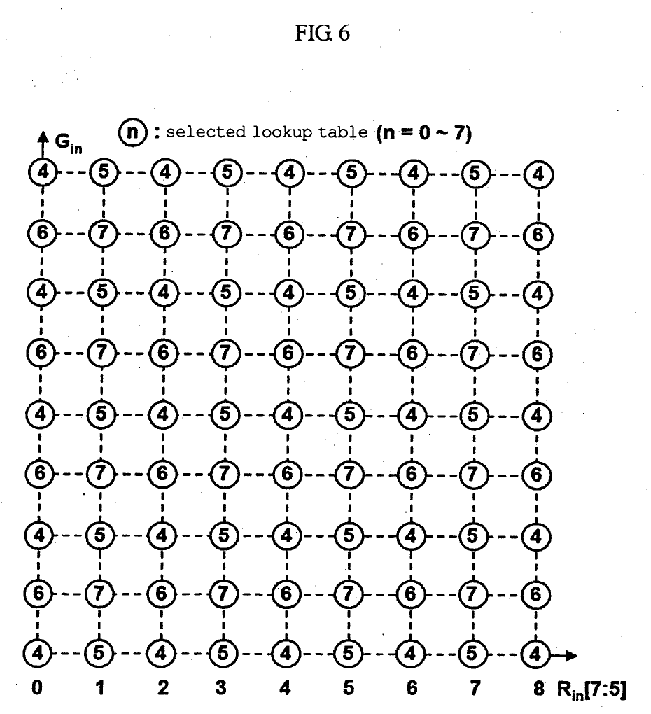

In this case, 729(=9×9×9) coordinate points are divisionally stored in the eight 1-D lookup tables 140. For example, mapped values for Rin=0, Gin=0 and Bin=0 points are stored at the first address of LUT0, mapped values for Rin=32, Gin=0 and Bin=0 points are stored at the first address of LUT1, and the respective points of a cube including an origin are uniformly stored in the first addresses of LUT0˜LUT7. Using this method, all of the 3-D data can be stored in the eight 1-D lookup tables, and examples of lookup table selection are illustrated in detail in FIGS. 5 and 6.

FIG. 5 illustrates the locations of lookup tables in which the mapped values of an entire 3-D region are stored when Bin values are 0, 64, 128, 192 and 256 (specially taken into account for interpolation). From this drawing, it can be understood that mapped values at the corresponding coordinates of each cube for a specific Bin value are stored using 1-D lookup tables LUT0˜LUT3. Furthermore, FIG. 6 illustrates the locations of lookup tables in which the mapped values of an entire 3-D region are stored when Bin values are 32, 96, 160 and 224. From this drawing, it can be understood that 1-D lookup tables LUT4˜LUT7 are utilized.

Meanwhile, the lookup table selection region of an entire cube can be constructed by connecting nine shapes in such a way as to alternately use the shapes of FIGS. 5 and 6. For example, for input in which Rin=10, Gin=10 and Bin=10, a cube including an origin is selected, and differential converted color data are brought from the point H, point J, point L and point N of FIG. 4.

The 1-D lookup tables 140 are constructed as described above and, therefore, can optimally and one-dimensionally construct the 3-D lookup table 100 that is composed of eight 1-D lookup tables having different depths. For example, in the case of LUT0 of FIG. 3, 5×5 pieces of color gamut mapped data, which are stored in LUT0, exist as understood from FIG. 3, such lookup tables exist at Bin[7:5]=0, 2, 4 and 6, and mapped data exist at Bin=256 to perform appropriate interpolation, so that a total of 64 addresses are included. In the case of LUT7 of FIG. 3, 4×4 pieces of color gamut mapped data exist, as shown in FIG. 6, and the lookup tables exist at Bin[7:5]=1, 3, 5 and 7, so that a total of 64 addresses are included.

The second consideration is that the output of each 1-D lookup table does not correspond to a specific vertex but corresponds to an arbitrary vertex. That is, like the above-described example, the output of LUT0 may correspond to point H of the cube of FIG. 4, point L and every point of the cube depending on input data values. In this case, the complexity of the interpolator is increased. Accordingly, as shown in FIG. 3, the data switch 16.0 is connected to the outputs of the eight 1-D lookup tables, so that interpolation is performed on arbitrary data according to the same rule with the location of the data being appropriately changed, thus optimally constructing the 3-D interpolator 200.

The adder 300 simultaneously receives differential converted values, which are generated by the 3-D interpolator, and image input values, which are used to calculate the differential converted values, calculates final converted color values, and outputs the finally converted color values. The calculation logic of the adder 300 is simple, but there are two considerations that should be taken into account.

The first consideration is that it is necessary to appropriately process overflow because overflow may occur in an adding process.

While color input signals pass through the 3-D lookup table and the 3-D interpolator, time delay corresponding to 4˜6 pixels occurs. Accordingly, the color input signals should be delayed by 4˜6 pixels before the color input signals are added to the output signals of the interpolator 200, and then an add operation is performed.

Through the above-described operation, the converted color values can be acquired as output values. The present invention has advantages in that it can not only reduce the implementation cost of hardware compared to the conventional method but is advantageous in having high-speed operation.

As described above, the present invention provides a hardware architecture that is capable of improving the color reproducibility of various types of display devices. Though various types of display devices are currently being developed, even the same type of display devices display different colors for the same color input signal. Different types of display devices generate greater differences in color. The present invention provides a method of improving the color reproducibility of display devices in real time in such a way as to measure the differences in color display on-line or off-line and appropriately download correction functions to the 3-D lookup table.

Furthermore, the present invention provides a further optimized hardware configuration by eliminating the inefficiency of the conventional color reproducibility improving device. That is, the conventional color reproducibility improving device employs the method of storing output color images having improved color reproducibility for color signal inputs. In contrast, the present invention can reduce the hardware cost of the 3-D lookup table by about 20-40% because only the differences between the color images having improved color reproducibility and input images are stored, and can considerably reduce entire hardware cost because processing is performed at a low quantization level with overall performance being kept the same.

The present invention is advantageous in that high-speed processing can be achieved due to a decrease in hardware implementation cost and the present invention can be applied to display devices having a resolution of 1080 p and to UXGA-class high-speed display devices.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for converting a color gamut of an input color image, comprising:
a three-dimensional (3-D) difference lookup table for storing differences between input values corresponding to upper n bits of the input color image and 3-D converted color data thereof;
a color interpolator for performing 3-D interpolation using 3-D converted data, which are output from the 3-D lookup difference lookup table, and 3-D color data corresponding to lower m bits of the input color image; and
an adder for receiving output of the color interpolator and the input color image, and outputting an image whose colors have been finally converted.

2. The apparatus as set forth in claim 1, wherein the 3-D difference lookup table outputs 3-D differential converted color values corresponding to eight vertices of a cube.

3. The apparatus as set forth in claim 1, wherein the color interpolator performs 3-D interpolation using 3-D differential converted color values corresponding to eight vertices of a cube, which are provided by the 3-D difference lookup table, and lower m bits of the input color image, and outputs a differential converted color value at a point inside the cube.

4. The apparatus as set forth in claim 1, wherein the 3-D difference lookup table comprises:
an address decoder for decoding and outputting 3-D data corresponding to upper n bits of the input color image;
a plurality of lookup tables having various depths, the lookup tables simultaneously outputting 3-D differential converted color values corresponding to eight vertices of a cube in response to the output of the address decoder every pixel clock; and
a data switching unit for changing locations of data output from the lookup tables in response to a control signal of the address decoder, and outputting values at uniform locations to the color interpolator.

5. The apparatus as set forth in claim 4, wherein the 3-D lookup table has a structure identical to that of a 3-D lookup table having a size of (2ⁿ+1)×(2ⁿ+1)×(2ⁿ+1), is composed of a plurality of one-dimensional (1-D) lookup tables, and stores data so as to simultaneously provide differential converted color values at vertices of a cube including a point in a color space.

6. The apparatus as set forth in claim 1, wherein the 3-D lookup table comprises:
the address decoder for decoding and outputting the 3-D data corresponding to the upper n bits of the input color image; and
the plurality of lookup tables having various depths, the lookup tables simultaneously outputting the 3-D differential converted color values corresponding to the eight vertices of a cube in response to the output of the address decoder every pixel clock.

7. A method of converting a color gamut of an input color image, comprising the steps of:
storing differences between input values corresponding to upper n bits of the input color image and 3-D converted color data thereof in a 3-D difference lookup table;
performing 3-D interpolation using 3-D converted data, which are output from the 3-D lookup difference lookup table, and 3-D color data corresponding to lower m bits of the input color image; and
receiving output of the color interpolator and the input color image, and outputting an image whose colors have been finally converted by an add operation.

8. The method as set forth in claim 7, wherein the step of storing the differences in the 3-D lookup table comprises the steps of:
calculating addresses of the eight 1-D lookup tables using the input RGB values; and
rearranging the color data, which are provided from the 1-D lookup tables, in appropriate order so as to facilitate the 3-D interpolation.
